(19) United States
(12) Patent Application Publication
(10) Pub. No.: US 2026/0277999 A1
(43) Pub. Date: Sep. 17, 2026

(54) GROUP-BASED PERSON RE-IDENTIFICATION

(71) Applicant: Infosys Limited, Bangalore (IN)

(72) Inventors: Ramjee RAJASEKARAN, Bengaluru (IN); Sidharth Subhash GHAG, Pune (IN); Gowri A.S., Chennai (IN)

(73) Assignee: Infosys Limited, Bangalore (IN)

(21) Appl. No.: 19/085,392

(22) Filed: Mar. 20, 2025

(30) Foreign Application Priority Data
Mar. 13, 2025 (IN) 202541022696

(51) Int. Cl. G06F 16/783; G06F 16/22; G06V 20/52

(52) U.S. Cl. CPC G06F 16/784; G06F 16/22; G06V 20/53

(57) ABSTRACT

A group-based person re-identification technique is provided in the present disclosure. A user group is created for related users. Each user group is tracked and trajectory data indicative of a path traveled by each user of the user group is generated. When users are detected in an area (e.g., in any camera view), the trajectory data is utilized to determine which user groups are predicted to be present in that area, and the detected users are compared with users of these user groups predicted to be present in the area. Based on this comparison, some of the detected users are re-identified to be part of one user group. Further, the remaining users of the same user group are re-identified using camera streams of neighboring areas. The initial user group is thus split into multiple sub-groups, with one sub-group including users present (e.g., re-identified) in one area.

### FIELD OF DISCLOSURE

Various embodiments of the present disclosure relate generally to image processing. More specifically, various embodiments of the present disclosure relate to group-based person re-identification.

### BACKGROUND

Cameras have become ubiquitous in public and private spaces, serving diverse applications such as surveillance, security, retail, or the like. In many of these applications, there is an increasing need to accurately identify and track individuals across multiple camera views to enhance monitoring, security, and operational efficiency. Traditionally, this task has relied heavily on human operators, such as security personnel, who manually observe and analyze feeds from multiple cameras to identify and follow the individuals. However, this manual approach is not only labor-intensive and prone to fatigue but also susceptible to errors and inconsistencies, which may compromise the effectiveness of monitoring systems.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for group-based person re-identification are provided substantially as shown in, and described in connection with, at least one of the figures.

The systems disclosed herein include processing circuitry. The processing circuitry is configured to create, using a first video stream of a first imaging device, a first user group. The first user group comprises a plurality of users that are related to each other. The processing circuitry is further configured to generate first trajectory data for the first user group. The first trajectory data is indicative of a path traveled by each user of the first user group. Further, the processing circuitry is configured to detect, in a second video stream of a second imaging device, one or more users. Based on the first trajectory data of the first user group, the processing circuitry is further configured to determine that the plurality of users of the first user group are predicted to be present in an area covered by the second imaging device. The processing circuitry is further configured to compare the one or more users with each user of the first user group and re-identify at least a first set of users of the one or more users based on the comparison of the one or more users with each user of the first user group. The re-identified first set of users is part of the first user group.

In some embodiments, the processing circuitry is further configured to determine that at least a second set of users of the first user group is not present in the area covered by the second imaging device. Further, the processing circuitry is configured to re-identify the second set of users using a third video stream of a third imaging device. The second set of users is present in an area covered by the third imaging device that is different from the area covered by the second imaging device. The processing circuitry is further configured to create, from the first user group, a second user group and a third user group comprising the first set of users and the second set of users, respectively.

In some embodiments, based on the first trajectory data and the creation of the second user group, the processing circuitry is further configured to generate second trajectory data for the second user group. The second trajectory data may indicate a path traveled by each user of the second user group. Based on the first trajectory data and the creation of the third user group, the processing circuitry is further configured to generate third trajectory data for the third user group, the third trajectory data indicating a path traveled by each user of the third user group.

In some embodiments, the system further comprises a storage element configured to store a user database. For a first user of the first set of users, based on the creation of the first user group, the user database includes (i) an identifier (ID) assigned to the first user, (ii) an ID assigned to the first user group, (iii) a reference feature profile of the first user, the reference feature profile being generated based on an appearance of the first user, and (iv) the first trajectory data associated with the first user. Further, for the first user, based on the creation of the second user group, the user database includes (i) the ID assigned to the first user, (ii) the ID assigned to the first user group, (iii) an ID assigned to the second user group, (iv) the reference feature profile of the first user, and (v) the second trajectory data associated with the first user.

In some embodiments, the processing circuitry is further configured to determine, based on the second trajectory data of the second user group, that the first set of users is predicted to be present in an area covered by a fourth imaging device. Further, the processing circuitry is configured to determine, based on the third trajectory data of the third user group, that the second set of users is predicted to be present in the area covered by the fourth imaging device. The processing circuitry is further configured to re-identify the first set of users and the second set of users using a fourth video stream of the fourth imaging device. Based on the re-identification of the first set of users and the second set of users, the processing circuitry is further configured to re-create the first user group that comprises the second user group and the third user group.

In some embodiments, the area covered by the third imaging device is within a predefined distance from the area covered by the second imaging device.

In some embodiments, to create the first user group, the processing circuitry is further configured to detect, in the first video stream, the plurality of users, and detect a position and a motion pattern of each user of the plurality of users. Based on the position and the motion pattern of each user of the plurality of users, the processing circuitry is further configured to derive a spatial proximity and a time duration spent within the spatial proximity for the plurality of users. The processing circuitry is further configured to determine that the plurality of users are related to each other based on the spatial proximity for the plurality of users being less than a spatial threshold and the time duration spent within the spatial proximity for the plurality of users being greater than a temporal threshold.

In some embodiments, to create the first user group, the processing circuitry is further configured to obtain a user input associated with at least one user of the plurality of users, the user input indicating that the plurality of users are related to each other.

In some embodiments, the user input is obtained by way of a quick response code.

In some embodiments, the first trajectory data comprises a set of spatio-temporal values for each user of the plurality of users, with a spatio-temporal value indicating a location at which the corresponding user is detected and an associated timestamp.

In some embodiments, the processing circuitry is further configured to predict, based on the first trajectory data and the re-identification of the first set of users in the area covered by the second imaging device, a next location of the first set of users. The predicted next location corresponds to an area covered by another imaging device that is different from the second imaging device.

In some embodiments, to compare the one or more users detected in the second video stream with each user of the first user group, the processing circuitry is further configured to detect, in the second video stream, an appearance of each user of the one or more users and generate a current feature profile for each user of the one or more users based on the detected appearance. The appearance indicates at least one of a set of apparel or a set of accessories associated with the corresponding user. To compare the one or more users detected in the second video stream with each user of the first user group, the processing circuitry is further configured to obtain a reference feature profile of each user of the plurality of users and compare the current feature profile of each user of the one or more users with the reference feature profile of each user of the plurality of users. The reference feature profile indicates a historical appearance of the corresponding user.

In some embodiments, the first set of users is re-identified from the one or more users based on the current feature profile of each of the first set of users matching a corresponding reference feature profile.

In some embodiments, the processing circuitry is further configured to generate the reference feature profile for each user of the plurality of users based on the creation of the first user group.

In some embodiments, each feature profile, of the current feature profile and the reference feature profile, corresponds to at least one of a set of state vectors or an embedding vector. The set of state vectors indicates presence or absence of each of the set of apparel and the set of accessories. The embedding vector is generated based on processing of the detected appearance using a feature extractor model trained with cosine metric learning and contrastive loss.

In some embodiments, the processing circuitry compares the current feature profile of each user of the one or more users with the reference feature profile of each user of the plurality of users using at least one of a k-reciprocal encoding or a k-nearest neighbor consistency check.

In some embodiments, based on the re-identification of the first set of users, the processing circuitry is further configured to track the first set of users in the area covered by the second imaging device.

In some embodiments, the re-identification of the first set of users is triggered based on a first-time detection of the first set of users in the area covered by the second imaging device.

In some embodiments, the re-identification of the first set of users is triggered based on an occlusion event associated with the first set of users in the area covered by the second imaging device.

In another embodiment of the present disclosure, a method is disclosed. The method comprises creating, by processing circuitry, using a first video stream of a first imaging device, a first user group. The first user group comprises a plurality of users that are related to each other. The method further comprises generating, by the processing circuitry, first trajectory data for the first user group. The first trajectory data is indicative of a path traveled by each user of the first user group. Further, the method comprises detecting, by the processing circuitry, in a second video stream of a second imaging device, one or more users. The method further comprises determining, by the processing circuitry, based on the first trajectory data of the first user group, that the plurality of users of the first user group are predicted to be present in an area covered by the second imaging device. The method further comprises comparing, by the processing circuitry, the one or more users with each user of the first user group, and re-identifying, by the processing circuitry, at least a first set of users of the one or more users based on the comparison of the one or more users with each user of the first user group. The re-identified first set of users is part of the first user group.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates a group-based person re-identification environment, consistent with disclosed embodiments of the present disclosure;

FIG. 2 is a block diagram of processing circuitry of the group-based person re-identification environment of FIG. 1, consistent with disclosed embodiments of the present disclosure;

FIG. 3 is a schematic diagram that illustrates an example scenario of a group-based person re-identification technique implemented in a retail store, consistent with disclosed embodiments of the present disclosure;

FIGS. 4A-4C, collectively, represent a flowchart that illustrates a method for group-based person re-identification, consistent with disclosed embodiments of the present disclosure; and

FIG. 5 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, to accurately identify and track individuals in multi-camera facilities, person re-identification systems may be employed. These systems utilize advanced machine learning and image processing techniques to analyze images or video frames, extract unique features, and use these features to match individuals across different camera views. Typically, convolutional neural networks are employed to capture static visual attributes such as body shape, clothing color, and textures. The extracted features are then stored in a database and compared with real-time data to facilitate identification and tracking. In such implementations, a data record, including various features, is maintained in a database for each user of a multi-camera facility. The re-identification may thus involve the comparison of a real-time generated feature profile of a user with the entire database.

Such comparisons may require extensive computational power and memory resources, leading to substantial processing overhead and latency. Further, as the size of the database expands, the computational demand escalates exponentially, making real-time or even near real-time identification increasingly challenging and resource-intensive. Additionally, in a multi-camera facility such as a retail store, customers often shop in groups. Conventional re-identification systems track individuals independently, which can cause errors in linking purchases to the correct account, leading to fragmented billing and inaccurate customer associations. The inability to recognize and track groups effectively further limits the efficiency of conventional re-identification implementations. The above-mentioned complexities highlight the inefficiencies of conventional re-identification approaches, particularly in high-traffic environments that require rapid and accurate identification across large populations.

The present disclosure addresses the above limitations by providing a group-based person re-identification technique. In the present disclosure, a user group is created at the entrance of a multi-camera facility (e.g., a retail store). The user group may include various users that are related to each other. Further, in a user database, for each user of the multi-camera facility, a data record is created. The data record may include an identifier (ID) assigned to the user, an ID assigned to the corresponding user group, and a reference feature profile of the user. The reference feature profile may be generated based on an appearance of the user. Further, each user group is tracked within the facility, and trajectory data indicative of a path traveled by each user of the user group is generated and stored in data records of all users of the corresponding user group.

When one or more users are detected in an area (e.g., in a camera view), the user database (e.g., the trajectory data) may be utilized to determine which user groups are predicted to be present in that area. Further, the detected users are compared with each user of all user groups that are predicted to be present in the area. For the comparison, a current feature profile is generated for each detected user and compared with the reference feature profiles of all the users that are predicted to be present in the area. Based on this comparison, some of the detected users are re-identified, with some re-identified users being part of one user group. Further, as the remaining users of the user group are not present in the area, neighboring camera streams may be checked to re-identify these remaining users. If the remaining users are re-identified in the neighboring areas, the initial user group may be split into multiple smaller user groups (also referred to as sub-groups), with one sub-group including users present (e.g., re-identified) in one area. IDs of such sub-groups and dynamically updated trajectory data are further included in the data records of the user database for corresponding users.

The present disclosure thus allows for effective group-based person re-identification in dynamic and crowded settings. As all the detected users are initially compared against only the user groups (e.g., the user group initially created at the entrance or the sub-groups dynamically formed as the users move through the retail store) that are predicted to be in the area where the users are detected, the computational power and memory resources are significantly reduced as compared to conventional techniques where each detected user is compared against the entire database. The reduced computational power and memory resources due to the formation of the initial user group as well as the dynamic formation of sub-groups may also lead to reduced processing overhead and latency. Additionally, the group-based re-identification ensures customers within the same group are effectively determined and tracked, thereby ensuring that purchases are accurately linked to a common group account. The re-identification technique of the present disclosure may thus be utilized in large-scale deployments requiring rapid identification across broad populations. The application area of the present disclosure may include any domain that utilizes re-identification systems. It is appreciated that the human mind is not equipped to conceptualize and engineer accurate, effective, and dynamic group-based person re-identification in multi-camera facilities such as retail stores, airports, or the like, given the digital interconnectedness of group-based person re-identification systems.

### Figure Description

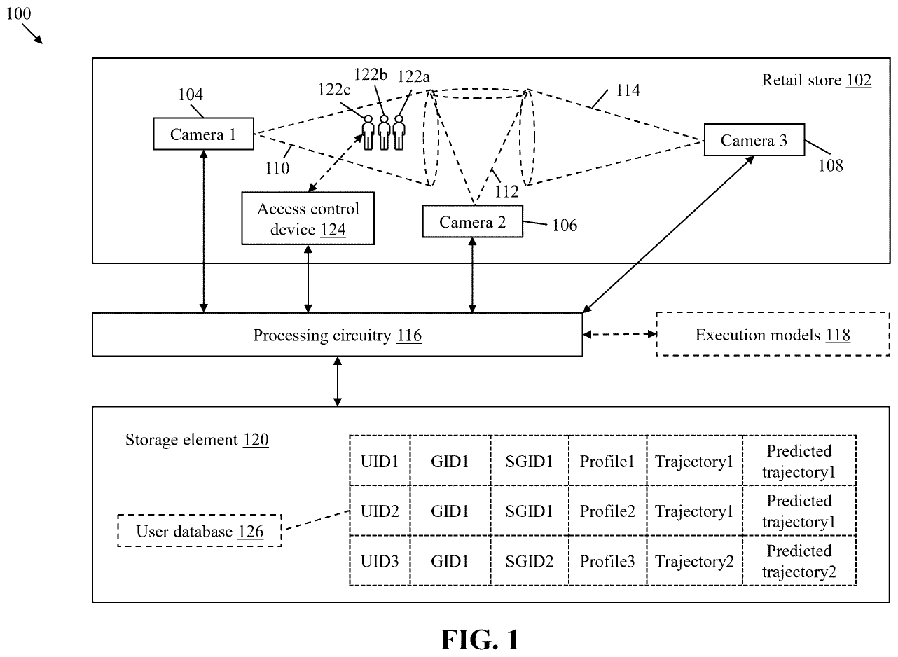

FIG. 1 is a schematic diagram that illustrates a group-based person re-identification environment 100, consistent with the disclosed embodiments of the present disclosure. The group-based person re-identification environment 100 (hereinafter referred to as the “environment 100”) includes a retail store 102. The retail store 102 may be equipped with various imaging devices to monitor various sections thereof. The placement of the imaging devices in the retail store 102 may be such that key areas such as entrances, aisles, checkouts, and other high-traffic zones, are covered. The imaging devices may also be positioned to capture different angles of an individual's body, face, and accessories. In an embodiment, the imaging devices may be fixed. In another embodiment, the position of the imaging devices may be dynamically adjusted based on user activity in the retail store 102. For the sake of brevity, the retail store 102 is shown to include three imaging devices (e.g., imaging devices 104-108). However, the scope of the present disclosure is not limited to it. In numerous embodiments, the retail store 102 may include more than three imaging devices covering the majority of the retail store 102.

In an embodiment, an imaging device may correspond to a camera. Thus, the imaging devices 104-108 are hereinafter referred to as “cameras 104-108”. The placement of cameras 104-108 may be within a predefined distance from each other. In an example, the predefined distance corresponds to 6 meters. However, in other embodiments, the predefined distance may have different values. Further, the cameras 104-108 may be synchronized by way of a network time protocol. Each camera has a field-of-view (FOV) that defines the extent of the observable scene captured by the camera lens. In other words, each camera may be configured to continuously capture a video of the associated FOV. The cameras 104-108 have FOVs 110-114, respectively. As illustrated in FIG. 1, the FOVs 110-114 may collectively cover a section of the retail store 102. The overlap between the FOVs 110-114 and potentially additional FOVs associated with other cameras improves tracking accuracy, while mitigating potential blind spots.

Conventionally, in multi-camera facilities (such as the retail store 102), person re-identification systems are employed to accurately identify and track individuals. These systems analyze video frames, extracting features like body shape, clothing colors, and textures, often employing convolutional neural networks for identification. However, this process requires significant computational power, as real-time profiles must be compared against an expanding database, leading to increased processing overhead and latency. As the database grows, computational demand rises exponentially, making real-time identification increasingly challenging. Further, the conventional re-identification systems track individuals separately, overlooking group dynamics. In a multi-camera facility, such as the retail store 102, customers frequently shop in groups, and the conventional re-identification systems fail to link purchases correctly, leading to fragmented billing and inaccurate customer associations. This inefficiency complicates customer experience and store operations. Overall, the conventional re-identification approaches struggle in high-traffic environments where rapid and precise identification is essential.

To overcome these challenges and provide an efficient, scalable solution that can handle group recognition and large-scale real-time tracking effectively, a group-based person re-identification technique is disclosed in the present disclosure. To facilitate such a group-based person re-identification technique, the environment 100 may further include processing circuitry 116, execution models 118, and a storage element 120. The processing circuitry 116, the execution models 118, and the storage element 120 collectively form a re-identification system of the present disclosure that executes the group-based person re-identification technique. The group-based person re-identification technique of the present disclosure is utilized to effectively identify and track user groups in the retail store 102 even when they split up. The group-based person re-identification technique of the present disclosure is explained in detail below.

### Group-based Person Re-Identification

The processing circuitry 116 may be coupled to the cameras 104-108 and the storage element 120. The processing circuitry 116 may include suitable logic, circuitry, interfaces, and/or code, executable by the circuitry, that may be configured to execute the group-based person re-identification in the retail store 102. The processing circuitry 116 may be configured to receive the video streams captured by each of the cameras 104-108.

### User Group Creation

In an embodiment, it is assumed that the first imaging device (e.g., the camera 104) covers the entrance of the retail store 102. Thus, the processing circuitry 116 may be further configured to detect, in a video stream captured by the camera 104, users 122a-122c. The processing circuitry 116 may be further configured to detect a position and a motion pattern of each of the users 122a-122c. Based on the position and the motion pattern of each of the users 122a-122c, the processing circuitry 116 may be further configured to derive a spatial proximity and a time duration spent within the spatial proximity for the users 122a-122c. The spatial proximity is indicative of the physical closeness or distance between users in a given space.

The processing circuitry 116 may be further configured to determine that the users 122a-122c are related to each other based on the spatial proximity for the users 122a-122c being less than a spatial threshold, and the time duration spent within the spatial proximity for the users 122a-122c being greater than a temporal threshold. In other words, if the users 122a-122c have been within a distance that is less than the spatial threshold and have maintained that proximity for a duration greater than the temporal threshold, it can be determined that the users 122a-122c are related to each other. In an embodiment, the storage element 120 may be configured to store the spatial threshold and the temporal threshold, and the processing circuitry 116 may be configured to retrieve the spatial threshold and the temporal threshold from the storage element 120 and compare the spatial proximity and the time duration spent within the spatial proximity for the users 122a-122c with the spatial threshold and the temporal threshold, respectively. In an example, the spatial threshold may be 0.3 meters and the temporal threshold may be 5 minutes. Thus, users (such as the users 122 a-122c) have to be within a distance of 0.3 meters for more than 5 minutes to be considered as a group. However, in other examples, the values of the spatial threshold and the temporal threshold may be different. The processing circuitry 116 may be configured to create a first user group that includes the users 122a-122c that are related to each other. The first user group may thus be created using the video stream captured by the camera 104.

The scope of the present disclosure is not limited to the processing circuitry 116 creating the first user group based on spatial and temporal factors as described above. In several embodiments, the user group creation may be controlled based on user inputs. For example, the processing circuitry 116 may be further configured to obtain a user input associated with at least one of the users 122a-122c. The user input may indicate that the users 122a-122c are related to each other. In an embodiment, the retail store 102 may have an access control device 124 at the entrance to control the entry of customers in the retail store 102. The access control device 124 may include a display unit (not shown) that may be configured to present a quick response (QR) code. One of the users 122a-122c may scan the QR code by way of an associated user device to provide the user input. For example, the user 122a may scan the QR code to register their entry in the retail store 102. Further, in an embodiment, the user 122a may scan the QR code two more times for the users 122b and 122c indicating the users 122a-122c are related to each other. Thus, the processing circuitry 116 may obtain the user input by way of the QR code. The scope of the present disclosure is not limited to the QR code and a specific use of the QR code being the trigger for user group creation. In several embodiments, the access control device 124 may provide various options for the customers to indicate that they are related to each other, without deviating from the scope of the present disclosure.

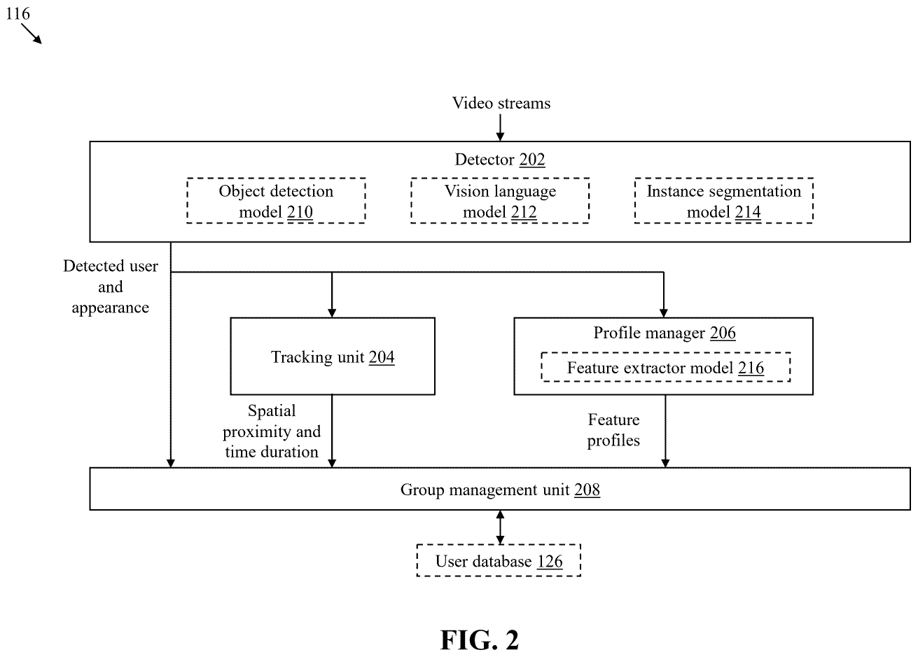

Based on the creation of the first user group, the processing circuitry 116 may be further configured to generate a reference feature profile for each of the users 122a-122c. To generate the reference feature profile for each user (e.g., the user 122a), the processing circuitry 116 may execute various operations. For example, the processing circuitry 116 may be further configured to detect, in the video frame captured by the camera 104, the user 122a and an appearance of the user 122a. The appearance may be indicative of at least one of a set of apparel or a set of accessories associated with the user 122a. Examples of an apparel may include a t-shirt, a shirt, jeans, a jacket, footwear, a hat, a cap, or the like. Further, examples of an accessory may include glasses, jewelry, a watch, or the like. In an embodiment, the processing circuitry 116 detects the user 122a and the appearance of the user 122a using at least one of the execution models 118. The execution models 118 may include various artificial intelligence (AI) models that are utilized by the processing circuitry 116 for the execution of the group-based person re-identification technique of the present disclosure. For the detection operation, the execution models 118 may include at least one of a group consisting of an object detection model, a vision language model (VLM), or an instance segmentation model. In an embodiment, all the object detection model, the VLM, and the instance segmentation model may be utilized for detecting the user 122a and the appearance of the user 122a. The object detection model, the VLM, and the instance segmentation model are explained in detail in FIG. 2.

The processing circuitry 116 may be further configured to process, using at least one of the execution models 118, the detected appearance of the user 122a to generate the reference feature profile of the user 122a. In such a scenario, the execution models 118 may include a feature extractor model. The feature extractor model may be trained with cosine metric learning and contrastive loss. The feature extractor model is explained in detail in FIG. 2.

The reference feature profile may include at least one of a set of state vectors or an embedding vector. The set of state vectors may indicate presence or absence of each of the set of apparel and the set of accessories. In other words, the set of state vectors may include a state vector for each apparel or accessory and an indication of whether the corresponding apparel or accessory is present or absent (e.g., worn or not worn by a user of the users 122a-122c). The embedding vector may be generated for each user based on processing of the detected appearance using the feature extractor model trained with cosine metric learning and contrastive loss.

The processing circuitry 116 may be further configured to generate first trajectory data for the first user group. The first trajectory data may be indicative of a path traveled by each user of the first user group. The first trajectory data may include a set of spatio-temporal values for each of the users 122a-122c. A spatio-temporal value may indicate a location at which the corresponding user is detected and an associated timestamp. The location may correspond to a camera location or a section of the retail store 102.

Based on the creation of the first user group, the processing circuitry 116 may be further configured to create a data record for each of the users 122a-122c and store the data record in the storage element 120. The storage element 120 may correspond to a hardware storage (for example, hard drive, solid-state drive, or the like) or a cloud storage (for example, cloud services). The storage element 120 may be configured to store a user database 126. The user database 126 may be configured to store the data records of various users of the retail store 102. For example, the user database 126 may store three data records for the users 122a-122c, respectively, as shown in FIG. 1.

For the user 122a, based on the creation of the first user group, the user database 126 includes an identifier (ID) assigned to the user 122a (shown as “UID1”), an ID assigned to the first user group (shown as “GID1”), the reference feature profile of the user 122a (shown as “Profile1”), and the first trajectory data associated with the user 122a (shown as “Trajectory1”). Similarly, for the user 122b, the user database 126 includes an ID assigned to the user 122b (shown as “UID2”), the ID assigned to the first user group (shown as “GID1”), the reference feature profile of the user 122b (shown as “Profile2”), and the first trajectory data associated with the user 122b. Further, for the user 122c, the user database 126 includes an ID assigned to the user 122c (shown as “UID3”), the ID assigned to the first user group (shown as “GID1”), the reference feature profile of the user 122c (shown as “Profile3”), and the first trajectory data associated with the user 122c. As the users 122a-122c are part of the same user group, the same group ID is assigned to each of the users 122a-122c. Further, at the entrance of the retail store 102, the users 122a-122c may have the same trajectory (e.g., Trajectory1). The processing circuitry 116 may be further configured to predict a next location of the users 122a-122c. The predicted next location may correspond to an area covered by another camera that is different from the camera 104. The user database 126 may thus include predicted trajectories of the users 122a-122c. The next location may be predicted based on the current and previous locations of the users 122a-122c. In an embodiment, at the initial stage (e.g., at the entrance of the retail store 102), the users 122a-122c may have the same predicted trajectory (shown as “Predicted trajectory1”). The processing circuitry 116 may be further configured to monitor the trajectory associated with each user of the first user group and update the user database 126 with the trajectory details.

### Re-Identification and Sub-Group Creation

As various users, including the users 122a-122c, move through the retail store 102, each user may enter the FOVs of different cameras. In an embodiment, the processing circuitry 116 may be further configured to detect, in a video stream of the camera 106, one or more users. Further, based on trajectory data of various user groups, the processing circuitry 116 may be configured to determine which user groups are predicted to be present in an area covered by the camera 106. In an embodiment, the predicted trajectory data stored in the user database 126 may be utilized for determining which user groups are predicted to be present in an area covered by a camera. For example, the processing circuitry 116 may be configured to determine that the users 122a-122c of the first user group are predicted to be present in the area covered by the camera 106 based on the first trajectory data.

The processing circuitry 116 may be further configured to compare the detected one or more users with each user of the first user group. To compare the one or more users detected in the video stream of the camera 106 with each user of the first user group, the processing circuitry 116 may execute various operations. For example, the processing circuitry 116 may be further configured to detect, in the video stream captured by the camera 106, an appearance of each user of the one or more users. The appearance may indicate at least one of the set of apparel or the set of accessories associated with the corresponding user. Further, the processing circuitry 116 may be configured to generate a current feature profile for each user of the one or more users based on the detected appearance. The processing circuitry 116 may be further configured to access the user database 126 and obtain the reference feature profiles of the users 122a-122c. In such a scenario, the reference feature profiles may indicate historical appearances of the users 122a-122c.

The processing circuitry 116 may be further configured to compare the current feature profile of each user of the one or more users with the reference feature profile of each of the users 122a-122c. The processing circuitry 116 may compare the current feature profile of each user of the one or more users with the reference feature profile of each of the users 122a-122c using at least one of a k-reciprocal encoding or a k-nearest neighbor consistency check. The k-reciprocal encoding is a technique used in feature representation, particularly for person re-identification and image retrieval tasks, thereby enhancing the robustness of similarity measures. In k-reciprocal encoding, a data point is considered k-reciprocal to another if both the data points appear in each other's k-nearest neighbor list. Further, the k-nearest neighbor consistency check is utilized to validate the similarity between the two data points to evaluate consistency. In an embodiment, the weightage of the set of vectors, the embedding vector, the k-reciprocal encoding, and the k-nearest neighbor consistency check in user comparison may vary based on various factors (e.g., layout of the retail store 102, efficiency of the execution models 118, or the like). Thus, weights may be dynamically assigned to each of the set of vectors, the embedding vector, the k-reciprocal encoding, and the k-nearest neighbor consistency check for accurate user comparison.

The processing circuitry 116 may be further configured to re-identify at least a first set of users of the one or more users based on the comparison of the one or more users with each user of the first user group. The re-identified first set of users may be part of the first user group. The first set of users is re-identified from the detected one or more users based on the current feature profile of each of the first set of users matching a corresponding reference feature profile. In an example, it is assumed that the users 122a and 122b move into the area covered by the camera 106. Thus, the first set of users may include the users 122a and 122b. The users 122a and 122b may thus be re-identified in the area covered by the camera 106.

The processing circuitry 116 may be further configured to determine that at least a second set of users of the first user group is not present in the area covered by the camera 106. In the abovementioned example, the processing circuitry 116 may determine that the user 122c is not present in the area covered by the camera 106. To re-identify the user 122c, the processing circuitry 116 may be further configured to analyze the video streams captured by neighboring cameras. In an embodiment, the processing circuitry 116 may be configured to re-identify the second set of users (e.g., the user 122c) using a video stream of the camera 108 such that the user 122c is present in an area covered by the camera 108. The area covered by the camera 108 may be different from the area covered by the camera 106. In an embodiment, the area covered by the camera 108 may be within the predefined distance from the area covered by the camera 106.

As the users from the same user group are re-identified at different locations, the processing circuitry 116 may be further configured to split the first user group. For example, the processing circuitry 116 may be configured to create, from the first user group, a second user group that comprises the users 122a and 122b, and a third user group that comprises the user 122c. In other words, the initial user group (e.g., the first user group) may be split into multiple smaller user groups (also referred to as sub-groups) such as the second and third user groups, with one sub-group including users present (e.g., re-identified) in one area.

Based on the first trajectory data and the creation of the second user group, the processing circuitry 116 may be further configured to generate second trajectory data for the second user group. The second trajectory data may indicate a path traveled by each user of the second user group. Thus, based on the creation of the second user group, for the user 122a, the user database 126 may further include an ID assigned to the second user group (shown as “SGID1”) and the second trajectory data associated with the user 122a. Similarly, for the user 122b, the user database 126 may include the ID assigned to the second user group (shown as “SGID1”) and the second trajectory data associated with the user 122b. Further, based on the first trajectory data and the creation of the third user group, the processing circuitry 116 may be further configured to generate third trajectory data for the third user group. The third trajectory data may indicate a path traveled by each user of the third user group. Thus, based on the creation of the third user group, for the user 122c, the user database 126 may include an ID assigned to the third user group (shown as “SGID2”) and the third trajectory data associated with the user 122c (shown as “Trajectory2”).

The processing circuitry 116 may be further configured to predict, based on the first trajectory data and the re-identification of the users 122a and 122b in the area covered by the camera 106, a next location of the users 122a and 122b. The predicted next location may correspond to an area covered by another camera that is different from the camera 106. The predicted next location may be stored in the user database 126 for the users 122a and 122b. Similarly, the processing circuitry 116 may be further configured to predict, based on the first trajectory data and the re-identification of the user 122c in the area covered by the camera 108, a next location of the user 122c. The predicted next location may correspond to an area covered by another camera that is different from the camera 108. The predicted next location (shown as “Predicted trajectory2”) may be stored in the user database 126 for the user 122c.

From the users detected in the video stream of the camera 106, two users (e.g., the users 122a and 122b) may be re-identified in the manner described above. The remaining users detected in the video stream of the camera 106 may be part of a different user group (e.g., an initial user group or a dynamically created sub-group) and may be re-identified in the same manner as described above. In other words, at a given time instance, in the area covered by the camera 106, multiple user groups (e.g., user groups formed initially at the entrance or dynamically created sub-groups) may be present. In several embodiments, if re-identification is pending for a user after comparing against all user groups predicted to be present in the area covered by the camera 106, the current feature profile of this user may be compared with all reference feature profiles of the user database 126 for re-identification.

The re-identification of the first set of users (e.g., the users 122a and 122b) is triggered based on a first-time detection of the first set of users (e.g., the users 122a and 122b) in the area covered by the camera 106. Based on the re-identification of the users 122a and 122b, the processing circuitry 116 may be further configured to track the users 122a and 122b in the area covered by the camera 106. In an embodiment, the processing circuitry 116 may track the users 122a and 122b using one or more bounding box based object tracking techniques. While the users 122a and 122b move through the area, an occlusion event may occur. An occlusion may correspond to the visibility of a user being partially or fully obstructed due to overlapping individuals, environmental objects, or movement within the area. The re-identification of the first set of users (e.g., the users 122a and 122b) may be triggered again based on the occlusion event associated with the first set of users (e.g., the users 122a and 122b) in the area covered by the camera 106. The re-identification may be executed in the similar manner as described above. Further, in some scenarios, while the users 122a and 122b move through the area, the users 122a and 122b may enter a dead zone. A dead zone may correspond to a section of the retail store 102 with no camera coverage. The re-identification of the first set of users (e.g., the users 122a and 122b) may be triggered again when the users 122a and 122b re-appear in any camera FOV. The re-identification may be executed in the similar manner as described above.

Thus, as a user group moves through the retail store 102, users in a user group may be categorized into multiple sub-groups based on the trajectory they take in the retail store 102. These sub-groups are utilized for re-identification. Purchases made by any user are automatically associated with the group's shared account. Thus, when users split or rejoin a user group, all transactions are accurately attributed to the common account.

The present disclosure thus allows for effective group-based person re-identification in dynamic and crowded settings. As all the detected users are initially compared against only the user groups (e.g., the user group initially created at the entrance or the sub-groups dynamically formed as the users move through the retail store 102) that are predicted to be in the area where the users are detected, the computational power and memory resources are significantly reduced as compared to conventional techniques where each user is compared against the entire database. The reduced computational power and memory resources due to the formation of the initial user group as well as the dynamic formation of sub-groups may also lead to reduced processing overhead and latency. Additionally, the group-based re-identification ensures customers within the same group are effectively determined and tracked, thereby ensuring that purchases are accurately linked to a common group account. The re-identification technique of the present disclosure may thus be utilized in large-scale deployments requiring rapid identification across broad populations. For example, the re-identification technique of the present disclosure may thus be implemented in frictionless shopping environments, such as the retail store 102, where purchases made by individual members of a group are tracked accurately while ensuring efficient use of computational resources.

At the exit of the retail store 102, all the users of a user group may regroup. For example, the processing circuitry 116 may be configured to determine, based on the second trajectory data of the second user group, that the users 122a and 122b are predicted to be present in an area covered by an exit camera (not shown), that is different from the cameras 104-108. The area covered by the exit camera may correspond to the exit of the retail store 102. The processing circuitry 116 may be further configured to determine, based on the third trajectory data of the third user group, that the user 122c is predicted to be present in the area covered by the exit camera. Further, the processing circuitry 116 may be configured to re-identify the users 122a-122c using a video stream of the exit camera in the similar manner as described above. Based on the re-identification of the users 122a-122c, the processing circuitry 116 may be further configured to re-create the first user group that comprises the second user group and the third user group. In an embodiment, the data records of the users 122a-122c may be deleted from the user database 126 after the users 122a-122c exit the retail store 102.

Although it is described that the first user group is re-created at the exit of the retail store 102, the scope of the present disclosure is not limited to it. In several embodiments, the first user group may be re-created in the similar manner as described above at any other section of the retail store 102 if the users 122a-122c are present in the same section. In other words, at any time instance, in an area covered by a camera, two sub-groups associated with the same user group cannot be present as such sub-groups may be merged into a newer sub-group based on the users of the two sub-groups, associated with the same original group, being present in the same area.

The scope of the present disclosure is not limited to a user group comprising three users. In numerous embodiments, a user group may include more than or less than three users, without deviating from the scope of the present disclosure. In such scenarios, based on the path traveled by users, various sub-groups may be created in the similar manner as described above.

The scope of the present disclosure is not limited to the use of state vectors and embedding vectors for the feature profile creation. In several embodiments, the processing circuitry 116 may be further configured to detect one or more additional attributes of a user. The one or more additional attributes may correspond to at least one of a group consisting of one or more facial features, a gait pattern, height, or a body shape. The one or more facial features may correspond to facial landmarks, facial geometry, skin texture, proportions and distances between features such as inter-ocular distance, nose-to-mouth distance, ear position, facial expressions, or any other unique identification characteristics. Further, the gait pattern may correspond to stride length, step length, step frequency, walking speed, swing and stance phases, knee and leg motion, upper body movement, posture and alignment, foot placement and angles, or the like. Further, the processing circuitry 116 may generate a feature profile (e.g., the reference feature profile and/or the current feature profile) of the user based on the one or more additional attributes detected in the corresponding video frame.

In the present disclosure, if the appearance of a user changes, the same change is reflected in the user database 126. In other words, the reference feature profile stored in the user database 126 is updated based on the appearance-change events.

A crowded setting, such as the retail store 102, includes a large number of people. In the present disclosure, the trajectory data of each user is utilized to limit the search space that is used for identifying the reference feature profile. This significantly reduces the computational load on the processing circuitry 116 and the advantage is exponential when measured in the context of the large number of people present in the retail store 102. As a result, the re-identification technique of the present disclosure is more efficient and effective as compared to conventional re-identification techniques where the features are compared with the entire master database of static user features.

In the retail store 102, the movement of a person is tracked via the cameras (e.g., the cameras 104-108), maintaining continuity of identity across the entire store. The group-based person re-identification implemented in the retail store 102 can be utilized for consistent user identification even when users are in dead zones or during an occlusion event, enabling personalized promotions and preventing theft or fraud. The accuracy of person re-identification is further improved by spatio-temporal matching, which combines spatial information (the location of each user) with temporal data (at a respective time instance).

The scope of the present disclosure is not limited to the group-based person re-identification in the retail store 102. In numerous embodiments, the group-based person re-identification technique of the present disclosure can be implemented in any scenario where individuals travel in groups. In one example, the group-based person re-identification technique of the present disclosure can be implemented in surveillance systems used in public spaces like airports, train stations, shopping malls, and city streets. In another example, the group-based re-identification technique of the present disclosure can be implemented in healthcare and elderly care monitoring like hospitals or old age homes. In yet another example, the group-based person re-identification technique of the present disclosure can be implemented in logistics and supply chain monitoring. In yet another example, the group-based person re-identification technique of the present disclosure can be implemented in the workplace and event analytics for monitoring the movement of teams in a large corporate event to optimize logistics and space utilization.

FIG. 2 is a block diagram of the processing circuitry 116, consistent with disclosed embodiments of the present disclosure. As illustrated in FIG. 2, the processing circuitry 116 may include a detector 202, a tracking unit 204, a profile manager 206, and a group management unit 208.

The detector 202 may be coupled to the cameras 104-108. The detector 202 may include suitable logic, circuitry, interfaces, and/or code, executable by the circuitry, that may be configured to perform one or more operations. For example, the detector 202 may be configured to receive the video streams captured by each of the cameras 104-108. The detector 202 may be further configured to detect, in a video stream, various users (e.g., the users 122a-122c) and appearances of the users. The detector 202 may utilize an object detection model 210, a VLM 212, an instance segmentation model 214, or a combination thereof, to detect each user and the appearance of the user. The execution models 118 may thus include the object detection model 210, the VLM 212, and the instance segmentation model 214.

The object detection model 210 is a type of ML model designed to identify and locate objects within an image or video. The object detection model 210 not only classifies objects into predefined categories but also outputs bounding boxes indicating their positions. For example, the object detection model 210 may localize the face of a user within the video frame by outputting a bounding box. Examples of the object detection model 210 may include You Only Look Once (YOLO) model, Faster Region-Based CNN (R-CNN), Mask R-CNN, or the like.

The VLM 212 is a type of AI model designed to process and understand information across both visual and textual modalities. Examples of the VLM 212 may include Contrastive Language-Image Pretraining (CLIP), Bootstrapped Language-Image Pretraining (BLIP), or the like. The VLM 212 may integrate computer vision and natural language processing to generate semantic feature information. In simple terms, the VLM 212 processes both the image and text present in the input and generates a text-based output upon extracting sparse features by interpreting contextual relationships between vision and language. For example, the VLM 212 may process the video frame of a user and interpret semantic descriptors useful for identifying the user based on their appearance. The semantic description of the person may include an appearance description (e.g., a person wearing a blue bottom wear, a brown jacket, a cap, and glasses). The VLM 212 may build semantic connections between the received video frames, even when visual features vary significantly. For example, if a person changes apparel, traditional visual matching might fail due to feature vector differences. However, the semantic descriptions detected by the VLM 212 bridge this gap, ensuring robust matching across changes in appearance. For instance, the VLM 212 detects appearance based on the visual features, and detects if the person is wearing a cap, glasses, a watch, or a jacket. Based on the detection, the VLM 212 generates either a ‘yes’ or a ‘no’ as a response for each query, providing context-aware information.

The instance segmentation model 214 is a specialized computer vision model that identifies and delineates each object in an image, assigning a distinct segmentation mask to every instance of a detected object. This task is more granular than object detection (which only identifies the bounding boxes) and semantic segmentation (which labels pixels but does not distinguish between instances). Examples of the instance segmentation model 214 may include Mask R-CNN, Detectron2, You Only Look At Coefficients (YOLACT), or the like. The instance segmentation model 214 may be configured to distinguish between different objects of the same class (e.g., two or more users) and assign a unique label to each instance. Once individual persons are segmented, the instance segmentation model 214 identifies and tracks each person across different frames or scenes, based on unique visual features like apparel, accessories, appearance, and pose.

The detector 202 thus combines the characteristics of the object detection model 210, the VLM 212, and the instance segmentation model 214 for detecting a user and the appearance of the user. For example, the received video stream is processed through the object detection model 210, the VLM 212, and the instance segmentation model 214 to identify persons in the received video frame by detecting objects that belong to the “person” class. The detected objects are segmented at the pixel level to identify individuals in complex environments where multiple people may overlap, occlude each other, or be close to one another. The integration of the object detection model 210, the VLM 212, and the instance segmentation model 214 leads to accurate and precise user and appearance detection in complex real-world scenarios.

The tracking unit 204 may be coupled to the detector 202. The tracking unit 204 may include suitable logic, circuitry, interfaces, and/or code, executable by the circuitry, that may be configured to monitor the positions and movements of various users within the retail store 102. For example, the tracking unit 204 may be configured to detect the position and the motion pattern of each user (e.g., the users 122a-122c). Based on the position and the motion pattern of each of the users 122a-122c, the tracking unit 204 may be further configured to derive the spatial proximity and the time duration spent within the spatial proximity for the users 122a-122c. The tracking unit 204 may be further configured to track user groups through the retail store 102 and generate tracking data. Additionally, the tracking unit 204 may be configured to generate predicted trajectories for each user group.

The profile manager 206 may be coupled to the detector 202. The profile manager 206 may include suitable logic, circuitry, interfaces, and/or code, executable by the circuitry, that may be configured to perform one or more operations. For example, the profile manager 206 may be configured to generate a feature profile for a user based on the detected appearance of the user. As illustrated in FIG. 2, the profile manager 206 may utilize a feature extractor model 216 to generate the feature profile. The feature extractor model 216 is trained with cosine metric learning and contrastive loss. The feature extractor model 216 may include convolutional neural networks or transformer-based models.

The feature profile may include the set of state vectors and/or the embedding vector. Each state vector may indicate presence or absence of an apparel or an accessory. The embedding vector may be generated based on processing the detected appearance using the feature extractor model 216. In an embodiment, the profile manager 206 may involve a convolution-based feature extraction function that may generate a compressed version of the appearance in a latent space. This compressed version of the appearance in the latent space may be referred to as the embedding vector.

The group management unit 208 may be coupled to the storage element 120, the detector 202, the tracking unit 204, and the profile manager 206. The group management unit 208 may include suitable logic, circuitry, interfaces, and/or code, executable by the circuitry, that may be configured to perform one or more operations. For example, the group management unit 208 may be further configured to receive the detected users and user appearances from the detector 202. Further, the group management unit 208 may be configured to receive the spatial proximity, the time duration spent within the spatial proximity for various users, the tracking data, and the predicted trajectories from the tracking unit 204. The group management unit 208 may be further configured to receive the feature profiles from the profile manager 206. The group management unit 208 may be further configured to dynamically manage user group creation, split, recombination, and utilization for effective operations of the retail store 102.

The group management unit 208 may be configured to determine that the users 122a-122c are related to each other based on the spatial proximity for the users 122a-122c being less than the spatial threshold, and the time duration spent within the spatial proximity for the users 122a-122c being greater than the temporal threshold. The spatial proximity for the users 122a-122c and the time duration spent within the spatial proximity for the users 122a-122c may be derived using the video stream captured by the camera 104 that covers the entrance of the retail store 102. Further, the group management unit 208 may be configured to create the first user group that includes the users 122a-122c. The scope of the present disclosure is not limited to the group management unit 208 creating the first user group based on spatial and temporal factors as described above. In several embodiments, the user group creation may be controlled based on user inputs. For example, the group management unit 208 may be configured to obtain the user input associated with at least one of the users 122a-122c. The user input may indicate that the users 122a-122c are related to each other.

Based on the creation of the first user group, the group management unit 208 may be further configured to create a data record for each of the users 122a-122c and store the data record in the storage element 120 (e.g., the user database 126). For example, the user database 126 may store three data records for the users 122a-122c. For the user 122a, based on the creation of the first user group, the user database 126 includes the ID assigned to the user 122a, the ID assigned to the first user group, the reference feature profile of the user 122a, and the first trajectory data associated with the user 122a. The group management unit 208 may be further configured to predict a next location of the users 122a-122c and store the predicted trajectories of the users 122a-122c in the user database 126.

As various users, including the users 122a-122c, move through the retail store 102, each user may enter the FOVs of different cameras. In an embodiment, the group management unit 208 may be configured to receive one or more users detected in a video stream of the camera 106. Further, based on trajectory data of various user groups, the group management unit 208 may be configured to determine which user groups are predicted to be present in an area covered by the camera 106. In an embodiment, the predicted trajectory data stored in the user database 126 may be utilized for determining which user groups are predicted to be present in an area covered by a camera. Based on the first trajectory data of the first user group, the group management unit 208 may be configured to determine that the users 122a-122c of the first user group are predicted to be present in the area covered by the camera 106.

The group management unit 208 may be further configured to compare the detected one or more users with each user of the first user group. To compare the one or more users detected in the video stream of the camera 106 with each user of the first user group, the group management unit 208 may be configured to compare the current feature profile generated for each user of the one or more users with the reference feature profile of each of the users 122a-122c. The group management unit 208 may be further configured to re-identify at least the first set of users of the one or more users based on the comparison of the one or more users with each user of the first user group. The re-identified first set of users may be part of the first user group. The first set of users is re-identified from the detected one or more users based on the current feature profile of each of the first set of users matching a corresponding reference feature profile. In an example, it is assumed that the users 122a and 122b move into the area covered by the camera 106. Thus, the first set of users may include the users 122a and 122b. The users 122a and 122b may thus be re-identified in the area covered by the camera 106.

The group management unit 208 may be further configured to determine that at least the second set of users of the first user group is not present in the area covered by the camera 106. In the abovementioned example, the group management unit 208 may determine that the user 122c is not present in the area covered by the camera 106. To re-identify the user 122c, the group management unit 208 may be further configured to analyze the video streams captured by neighboring cameras. In an embodiment, the group management unit 208 may be configured to re-identify the second set of users (e.g., the user 122c) using the video stream of the camera 108 such that the user 122c is present in the area covered by the camera 108. The area covered by the camera 108 may be different from the area covered by the camera 106. In an embodiment, the area covered by the camera 108 may be within the predefined distance from the area covered by the camera 106.

As the users from the same user group are re-identified at different locations, the group management unit 208 may be further configured to split the first user group. For example, the group management unit 208 may be configured to create, from the first user group, the second user group that comprises the users 122a and 122b, and the third user group that comprises the user 122c.

Based on the first trajectory data and the creation of the second user group, the group management unit 208 may be further configured to generate the second trajectory data for the second user group. Thus, based on the creation of the second user group, for the user 122a, the user database 126 may include the ID assigned to the second user group and the second trajectory data associated with the user 122a. Similarly, based on the first trajectory data and the creation of the third user group, the group management unit 208 may be further configured to generate the third trajectory data for the third user group. The group management unit 208 may be further configured to predict, based on the first trajectory data and the re-identification of the users 122a and 122b in the area covered by the camera 106, a next location of the users 122a and 122b and store the predicted next location in the user database 126 for the users 122a and 122b. Similarly, the group management unit 208 may be further configured to predict, based on the first trajectory data and the re-identification of the user 122c in the area covered by the camera 108, a next location of the user 122c and store the predicted next location in the user database 126 for the user 122c.

At the exit of the retail store 102, all the users of a user group may regroup. For example, the group management unit 208 may be configured to determine, based on the second trajectory data of the second user group, that the users 122a and 122b are predicted to be present in an area covered by an exit camera (not shown), that is different from the cameras 104-108. The area covered by the exit camera may correspond to the exit of the retail store 102. The group management unit 208 may be further configured to determine, based on the third trajectory data of the third user group, that the user 122c is predicted to be present in the area covered by the exit camera. Further, the group management unit 208 may be configured to re-identify the users 122a-122c using a video stream of the exit camera in the similar manner as described above. Further, based on the re-identification of the users 122a-122c, the group management unit 208 may be configured to re-create the first user group that comprises the second user group and the third user group.

Unlike traditional systems, where object detection and re-identification are integrated into a single pipeline, in the present disclosure both operations correspond to distinct flows. Thus, in the present disclosure, the re-identification operation is triggered only when users are detected in new camera FOVs or an occlusion event is detected. This avoids redundant computation and focuses computational resources on critical moments, improving efficiency and robustness.

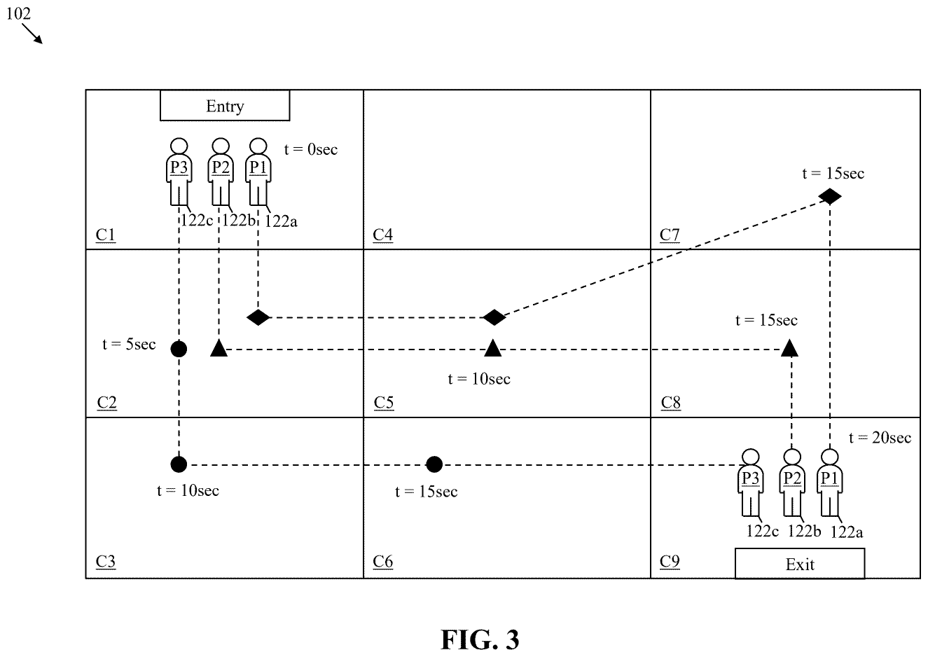

FIG. 3 is a schematic diagram that illustrates an example scenario of the group-based person re-identification technique implemented in the retail store 102, consistent with disclosed embodiments of the present disclosure.

As illustrated in FIG. 3, the retail store 102 may be divided into various areas, each area covered by one camera. For example, the retail store 102 may include cameras C1-C9, with the camera C1 covering the entrance and the camera C9 covering the exit. In FIG. 3, a box may represent the area covered by one camera. For example, the box including the label ‘C1’ may represent the area covered by the camera C1.

As illustrated in FIG. 3, at time instance t₀ (i.e., t=0 seconds (sec)), the users 122a-122c enter the retail store 102. The users 122a-122c may be detected using the video stream captured by the camera C1. In an embodiment, the camera C1 may be the camera 104 of FIG. 1. Based on the spatial proximity and time duration spent within the spatial proximity for the users 122a-122c, the users 122a-122c may be determined to be related to each other. Thus, the first user group that includes the users 122a-122c may be created.

At time instance t₁ (i.e., t=5 sec), the users 122a-122c may move to the area covered by the camera C2. Further, in FIG. 3, the user 122a is represented by a diamond shape, the user 122b is represented by a triangle shape, and the user 122c is represented by a circle shape. The details of the first user group (e.g., the users 122a-122c) stored in the user database 126 may be utilized to re-identify the users 122a-122c in the area covered by the camera C2. As all the users of the first user group are re-identified in the area covered by the same camera, group splitting is not performed. Further, at time instance t₁, based on previous and current locations of the users 122a-122c, the first user group may be predicted to be present in the area covered by the camera C5. The prediction may be based on the type of products displayed in the area covered by the camera C5, the purchase history of the users 122a-122c, or the like.

At time instance t₂ (i.e., t=10 sec), the users 122a and 122 b may move to the area covered by the camera C5, whereas the user 122c may move to an area covered by the camera C3. The details of the first user group (e.g., the users 122a-122c) stored in the user database 126 may be utilized to re-identify the users 122a and 122b in the area covered by the camera C5. Although not shown, other users of different user groups (e.g., user groups formed at the entrance or the dynamically formed sub-groups) may also be present in the area covered by the camera C5. In such a scenario, these users may also be compared with all the user groups (including the first user group) predicted to be present in the area covered by the camera C5. As these users do not match with the user 122c, it may be determined that the user 122c of the first user group is not present in the area covered by the camera C5. In such a scenario, the video streams of neighboring cameras may be utilized to re-identify the user 122c. For example, the video stream captured by the camera C3 may be utilized to re-identify the user 122c. As the users of the first user group are re-identified in different areas, the first user group may be split into two user groups: the second user group including the users 122a and 122b, and the third user group including the user 122c. The two user groups are then tracked independently, whilst maintaining their association with the main user group (e.g., the first user group). In such a scenario, purchases made by any user are automatically associated with the group's shared account. Thus, even when users split, all transactions are accurately attributed to the common account.

At time instance t₃ (i.e., t=15 sec), the user 122a may move to the area covered by the camera C7, the user 122b may move to the area covered by the camera C8, and the user 122c may move to an area covered by camera C6. Each user may be re-identified in the similar manner as described above. Further, as the users of the second user group are re-identified in different areas, the second user group may be split into two user groups: a fourth user group including the user 122a, and a fifth user group including the user 122b. In other words, the first user group may be split into three user groups: the fourth user group including the user 122a, the fifth user group including the user 122b, and the third user group including the user 122c. The three user groups are then tracked independently, whilst maintaining their association with the main user group (e.g., the first user group).

At time instance t4 (i.e., t=20 sec), the users 122 a-122c may regroup at the exit of the retail store 102. In such a scenario, based on the trajectory data of the third through fifth user groups, it may be determined that all the users 122a-122c are predicted to be present in the area covered by the camera C9. The users 122a-122c may thus be re-identified using the video stream of the camera C9. As the users 122a-122c are re-identified in the same area, the first user group may be re-created. As the purchases made by the users 122a-122c at each area of the retail store 102 are linked to the common account associated with the first user group, the checkout process may be executed smoothly and accurately.

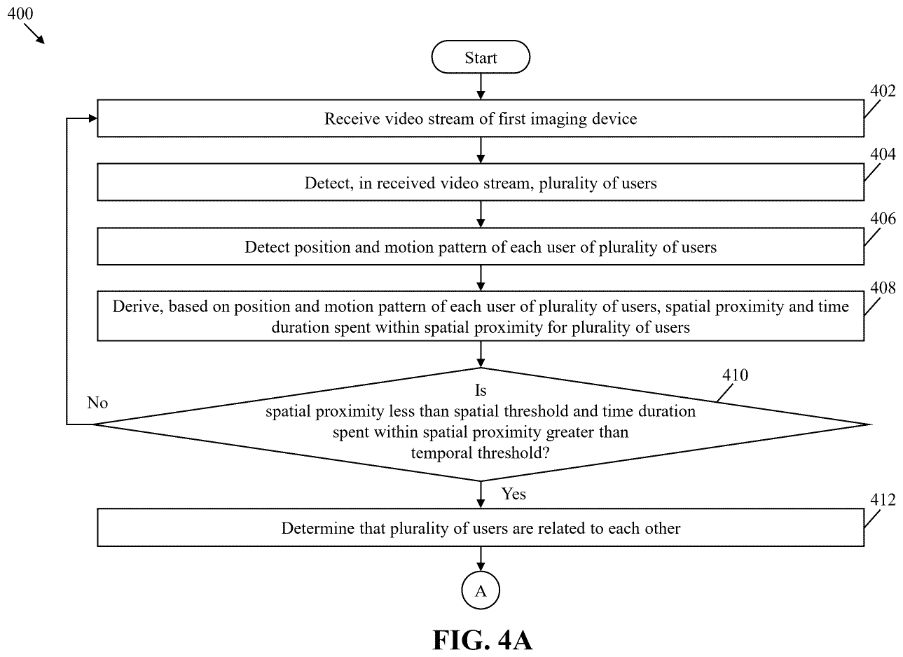

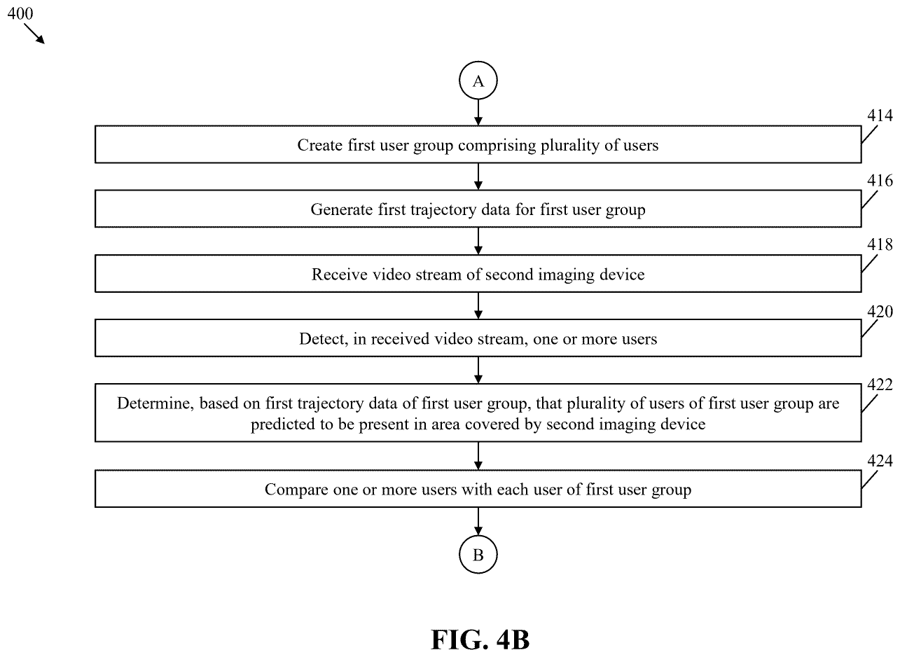

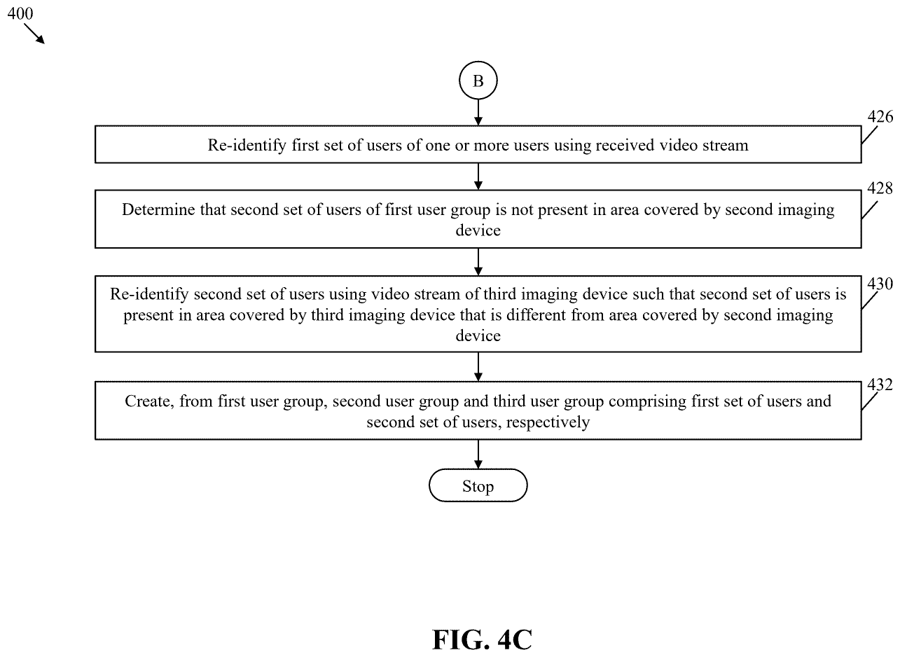

FIGS. 4A-4C, collectively, represent a flowchart 400 that illustrates a method for group-based person re-identification, consistent with disclosed embodiments of the present disclosure.

Referring to FIG. 4A, at 402, the processing circuitry 116 may receive a video stream of a first imaging device (e.g., the camera 104). At 404, the processing circuitry 116 may detect, in the received video stream, a plurality of users (e.g., the users 122a-122c). At 406, the processing circuitry 116 may detect a position and a motion pattern of each user of the plurality of users. At 408, the processing circuitry 116 may derive, based on the position and the motion pattern of each user of the plurality of users, a spatial proximity and a time duration spent within the spatial proximity for the plurality of users.

At 410, the processing circuitry 116 may determine whether the spatial proximity is less than a spatial threshold and whether the time duration spent within the spatial proximity is greater than a temporal threshold. If at 410, it is determined that the spatial proximity is greater than the spatial threshold or the time duration spent within the spatial proximity is less than the temporal threshold, 402 is performed. However, if at 410, it is determined that the spatial proximity is less than the spatial threshold and the time duration spent within the spatial proximity is greater than the temporal threshold, 412 is performed. At 412, the processing circuitry 116 may determine that the plurality of users are related to each other.

Referring to FIG. 4B, at 414, the processing circuitry 116 may create a first user group comprising the plurality of users. At 416, the processing circuitry 116 may generate first trajectory data for the first user group. The first trajectory data may be indicative of a path traveled by each user of the first user group. At 418, the processing circuitry 116 may receive a video stream of a second imaging device (e.g., the camera 106). At 420, the processing circuitry 116 may detect, in the received video stream, one or more users. At 422, the processing circuitry 116 may determine, based on the first trajectory data of the first user group, that the plurality of users of the first user group are predicted to be present in an area covered by the second imaging device. At 424, the processing circuitry 116 may compare the one or more users with each user of the first user group.

Referring to FIG. 4C, at 426, the processing circuitry 116 may re-identify a first set of users of the one or more users using the received video stream. The re-identified first set of users is part of the first user group. At 428, the processing circuitry 116 may determine that a second set of users of the first user group is not present in the area covered by the second imaging device. At 430, the processing circuitry 116 may re-identify the second set of users using a video stream of a third imaging device (e.g., the camera 108) such that the second set of users is present in an area covered by the third imaging device that is different from the area covered by the second imaging device. At 432, the processing circuitry 116 (e.g., the group management unit 208) may create, from the first user group, a second user group and a third user group comprising the first set of users and the second set of users, respectively.

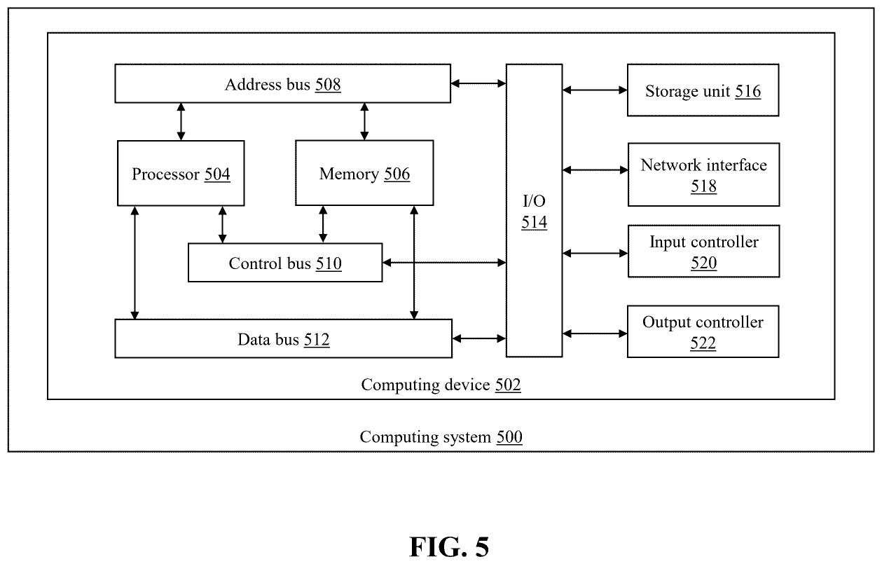

FIG. 5 shows an example computing system for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 can be implemented as a conventional computer system, an embedded controller, a laptop, a server, a mobile device, a smartphone, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, and a data bus 512.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access-memory (RAM), a static random-access-memory (SRAM), a dynamic random-access-memory (DRAM), and a synchronous dynamic random-access-memory (SDRAM). The memory 506 may include single or multiple memory modules. While the memory 506 is depicted as part of the computing device 502, a person skilled in the art will recognize that the memory 506 can be separate from the computing device 502.

The memory 506 may store information that can be accessed by the processor 504. For instance, the memory 506 (e.g., one or more non-transitory computer-readable storage mediums, memory devices) may include computer-readable instructions (not shown) that can be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that when executed by the processor 504 cause the processor 504 to perform operations such as any of the operations and functions for which the computing system 500 is configured, as described herein. Additionally, or alternatively, the memory 506 may store data (not shown) that can be obtained, received, accessed, written, manipulated, created, and/or stored. The data can include, for instance, the data and/or information described herein in relation to FIGS. 1-4. In some implementations, the computing device 502 may obtain from and/or store data in one or more memory device(s) that are remote from the computing system 500.

The computing device 502 may further include an input/output (I/O) interface 514 communicatively coupled to the address bus 508, the control bus 510, and the data bus 512. The data bus 512 may include a plurality of tunnels that may support communication in the environment 100. The I/O interface 514 is configured to couple to one or more external devices (e.g., to receive and send data from/to one or more external devices). Such external devices, along with the various internal devices, may also be known as peripheral devices. The I/O interface 514 may include both electrical and physical connections for operably coupling the various peripheral devices to the computing device 502. The I/O interface 514 may be configured to communicate data, addresses, and control signals between the peripheral devices and the computing device 502. The I/O interface 514 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 514 is configured to implement only one interface or bus technology. Alternatively, the I/O interface 514 is configured to implement multiple interfaces or bus technologies. The I/O interface 514 may include one or more buffers for buffering transmissions between one or more external devices, internal devices, the computing device 502, or the processor 504. The I/O interface 514 may couple the computing device 502 to various input devices, including touch screens, scanners, biometric readers, electronic digitizers, receivers, touchpads, cameras, keyboards, any other pointing devices, or any combinations thereof. The I/O interface 514 may couple the computing device 502 to various output devices, including printers, projectors, tactile feedback devices, automation control, robotic components, actuators, transmitters, signal emitters, lights, and so forth.

The computing system 500 may further include a storage unit 516, a network interface 518, an input controller 520, and an output controller 522. The storage unit 516, the network interface 518, the input controller 520, and the output controller 522 are communicatively coupled to the central control unit (e.g., the memory 506, the address bus 508, the control bus 510, and the data bus 512) via the I/O interface 514. The network interface 518 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 518 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 516 is a computer-readable medium, preferably a non-transitory computer-readable medium, comprising one or more programs, the one or more programs comprising instructions which when executed by the processor 504 cause the computing system 500 to perform the method steps of the present disclosure. Alternatively, the storage unit 516 is a transitory computer-readable medium. The storage unit 516 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 516 stores one or more operating systems, application programs, program modules, data, or any other information. The storage unit 516 is part of the computing device 502. Alternatively, the storage unit 516 is part of one or more other computing machines that are in communication with the computing device 502, such as servers, database servers, cloud storage, network attached storage, and so forth.

The input controller 520 may include suitable logic, circuitry, interfaces, and/or code, executable by the circuitry, that may be configured to control one or more input devices that may be configured to receive video frames. The output controller 522 may include suitable logic, circuitry, interfaces, and/or code, executable by the circuitry, that may be configured to control one or more output devices that may be configured to output feature profiles, user group details, or the like.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods of group-based person re-identification. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
processing circuitry configured to:
create, using a first video stream of a first imaging device, a first user group, wherein the first user group comprises a plurality of users that are related to each other;
generate first trajectory data for the first user group, wherein the first trajectory data is indicative of a path traveled by each user of the first user group;
detect, in a second video stream of a second imaging device, one or more users;
determine, based on the first trajectory data of the first user group, that the plurality of users of the first user group are predicted to be present in an area covered by the second imaging device;
compare the one or more users with each user of the first user group; and
re-identify at least a first set of users of the one or more users based on the comparison of the one or more users with each user of the first user group, wherein the re-identified first set of users is part of the first user group.

2. The system of claim 1, wherein the processing circuitry is further configured to:
determine that at least a second set of users of the first user group is not present in the area covered by the second imaging device;
re-identify the second set of users using a third video stream of a third imaging device such that the second set of users is present in an area covered by the third imaging device that is different from the area covered by the second imaging device; and
create, from the first user group, a second user group and a third user group comprising the first set of users and the second set of users, respectively.

3. The system of claim 2,
wherein based on the first trajectory data and the creation of the second user group, the processing circuitry is further configured to generate second trajectory data for the second user group, the second trajectory data indicating a path traveled by each user of the second user group, and
wherein based on the first trajectory data and the creation of the third user group, the processing circuitry is further configured to generate third trajectory data for the third user group, the third trajectory data indicating a path traveled by each user of the third user group.

4. The system of claim 3, further comprising a storage element configured to store a user database, wherein for a first user of the first set of users,
based on the creation of the first user group, the user database includes (i) an identifier (ID) assigned to the first user, (ii) an ID assigned to the first user group, (iii) a reference feature profile of the first user, the reference feature profile being generated based on an appearance of the first user, and (iv) the first trajectory data associated with the first user, and
based on the creation of the second user group, the user database includes (i) the ID assigned to the first user, (ii) the ID assigned to the first user group, (iii) an ID assigned to the second user group, (iv) the reference feature profile of the first user, and (v) the second trajectory data associated with the first user.

5. The system of claim 3, wherein the processing circuitry is further configured to:
determine, based on the second trajectory data of the second user group, that the first set of users is predicted to be present in an area covered by a fourth imaging device;
determine, based on the third trajectory data of the third user group, that the second set of users is predicted to be present in the area covered by the fourth imaging device;
re-identify the first set of users and the second set of users using a fourth video stream of the fourth imaging device; and
re-create, based on the re-identification of the first set of users and the second set of users, the first user group that comprises the second user group and the third user group.

6. The system of claim 2, wherein the area covered by the third imaging device is within a predefined distance from the area covered by the second imaging device.

7. The system of claim 1, wherein to create the first user group, the processing circuitry is further configured to:
detect, in the first video stream, the plurality of users;
detect a position and a motion pattern of each user of the plurality of users;
derive, based on the position and the motion pattern of each user of the plurality of users, a spatial proximity and a time duration spent within the spatial proximity for the plurality of users; and
determine that the plurality of users are related to each other based on (i) the spatial proximity for the plurality of users being less than a spatial threshold and (ii) the time duration spent within the spatial proximity for the plurality of users being greater than a temporal threshold.

8. The system of claim 1, wherein to create the first user group, the processing circuitry is further configured to obtain a user input associated with at least one user of the plurality of users, the user input indicating that the plurality of users are related to each other.

9. The system of claim 8, wherein the user input is obtained by way of a quick response code.

10. The system of claim 1, wherein the first trajectory data comprises a set of spatio-temporal values for each user of the plurality of users, with a spatio-temporal value indicating a location at which the corresponding user is detected and an associated timestamp.

11. The system of claim 1,
wherein the processing circuitry is further configured to predict, based on the first trajectory data and the re-identification of the first set of users in the area covered by the second imaging device, a next location of the first set of users, and
wherein the predicted next location corresponds to an area covered by another imaging device that is different from the second imaging device.

12. The system of claim 1, wherein to compare the one or more users detected in the second video stream with each user of the first user group, the processing circuitry is further configured to:
detect, in the second video stream, an appearance of each user of the one or more users, the appearance indicating at least one of a set of apparel or a set of accessories associated with the corresponding user;
generate a current feature profile for each user of the one or more users based on the detected appearance;
obtain a reference feature profile of each user of the plurality of users, the reference feature profile indicating a historical appearance of the corresponding user; and
compare the current feature profile of each user of the one or more users with the reference feature profile of each user of the plurality of users.

13. The system of claim 12, wherein the first set of users is re-identified from the one or more users based on the current feature profile of each of the first set of users matching a corresponding reference feature profile.

14. The system of claim 12, wherein the processing circuitry is further configured to generate the reference feature profile for each user of the plurality of users based on the creation of the first user group.

15. The system of claim 12, wherein each feature profile, of the current feature profile and the reference feature profile, corresponds to at least one of:
a set of state vectors that indicates presence or absence of each of the set of apparel and the set of accessories, or
an embedding vector that is generated based on processing of the detected appearance using a feature extractor model trained with cosine metric learning and contrastive loss.

16. The system of claim 12, wherein the processing circuitry compares the current feature profile of each user of the one or more users with the reference feature profile of each user of the plurality of users using at least one of a k-reciprocal encoding or a k-nearest neighbor consistency check.

17. The system of claim 1, wherein based on the re-identification of the first set of users, the processing circuitry is further configured to track the first set of users in the area covered by the second imaging device.

18. The system of claim 1, wherein the re-identification of the first set of users is triggered based on a first-time detection of the first set of users in the area covered by the second imaging device.

19. The system of claim 1, wherein the re-identification of the first set of users is triggered based on an occlusion event associated with the first set of users in the area covered by the second imaging device.

20. A method, comprising:
creating, by processing circuitry, using a first video stream of a first imaging device, a first user group, wherein the first user group comprises a plurality of users that are related to each other;
generating, by the processing circuitry, first trajectory data for the first user group, wherein the first trajectory data is indicative of a path traveled by each user of the first user group;
detecting, by the processing circuitry, in a second video stream of a second imaging device, one or more users;
determining, by the processing circuitry, based on the first trajectory data of the first user group, that the plurality of users of the first user group are predicted to be present in an area covered by the second imaging device;
comparing, by the processing circuitry, the one or more users with each user of the first user group; and
re-identifying, by the processing circuitry, at least a first set of users of the one or more users based on the comparison of the one or more users with each user of the first user group, wherein the re-identified first set of users is part of the first user group.
